(19) United States
(12) Patent Application Publication
(10) Pub. No.: US 2012/0020840 A1
(43) Pub. Date: Jan. 26, 2012

(54) DETECTION SYSTEM

(75) Inventor: Ian Muir Craig, Broxbum (GB)

(73) Assignee: Selex Galileo Limited, Essex (GB)

(21) Appl. No.: 13/258,306

(22) PCT Filed: Mar. 30, 2010
(86) PCT No.: PCT/EP2010/054175

§ 371 Date: Sep. 21, 2011

(30) Foreign Application Priority Data
Mar. 30, 2009 (GB) 0905325.7

(51) Int. Cl. G01N 21/00

(52) U.S. Cl. 422/82.05

(57) ABSTRACT

A system for detecting small quantities of agent such as DNA in a larger volume of substance is disclosed. The system includes a radiation emitter arranged so as to emit radiation on to a quantity of substance containing the agent. The incident radiation excites the agent causing it to emit radiation detectable by suitable detection means. The incident and emitted radiation are directed by a light guide that also acts so as to contain the substance being monitored.

The present invention relates to a detection system used to identify DNA or RNA based organisms. More specifically, but not exclusively, it relates to detection instruments including an optical arrangement. The instruments find applications in pathology, forensics and infectious disease diagnostics.

The invention is used in an instrument that contains one or more micro sized reaction vessels. Each vessel is used to contain trace amounts of the DNA/RNA targets of interest. The trace amounts may either be directly injected into the reaction vessel or may be captured in the reaction vessel by another instrument sub system.

The instrument may also contain further sub systems that break target cell membranes, or separate potential interferants to the biochemical method described below.

A biochemical method from the polymerase chain reaction (PCR) family is used to rapidly produce multiple copies of a target nucleic acid sequence at almost an exponential rate. These multiple copies, which are held in a solution, can then be detected by a further sub system that operates on the bulk properties of the PCR mixture i.e. this sub system operates at a macroscopic level The combined biochemical and macroscopic system as described above have the capability of distinguishing strains of organisms of the same species.

Further details of the PCR technique can be found in U.S. Pat. Nos. 4,683,195, 4,683,202, 4,800,159, and 4,965,188.

PCR methodology can be sub classified under the categories of duplex, multiplex, single tube, nested, and real time.

Micro sizing of single chamber reaction vessels gives important positive attributes to the biochemical process. These attributes include:—

i) Minimising volume of reagents;
ii) Reduction in electrical power for the thermal cycle process as a consequence of the reduced thermal capacitance
iii) Reduction the thermal cycle time for the PCR process
iv) Improvement in the controllability of temperatures and minimization of transition times between the fixed hold temperatures
v) Improvement in system sensitivity as due to reduction in volume of the reaction vessel
vi) Minimisation of PCR chemistry contamination due to fluid transportations

A negative aspect of micro sized reaction chambers is the increased difficulty of physically detecting the build up of amplified DNA because of the small volume of reagents that are used. In real-time PCR it is desirable to monitor the build up of amplified PCR once per PCR cycle, and thus obtain the whole amplification profile. Quantitative real time PCR is more precise than end point determination but demands a high sensitivity requirement from the PCR progress monitoring sensor because the small volume of the reaction chamber.

Known PCR based biodetection systems are described in following, U.S. Pat. No. 6,174,670 B1, U.S. Pat. No. 6,387,621, U.S. Pat. No. 7,081,226, and U.S. Pat. No. 6,699,713. However, existing technical solutions such as those described by the above patents are bulky, expensive, not amenable to aerosol analysis and in some cases cannot perform multiple cell analysis.

Other known optical techniques are not able to couple light easily into multiple micro sized reaction vessels. Other known non-optical biosensing methods such as impedance measurement as described in U.S. Pat. No. 6,835,552B2, U.S. Pat. No. 7,135,294, and U.S. Pat. No. 7,157,232B2 and international publication WO 99/10530 have not found their way into commercial products because of lack of sensitivity and cost effectiveness.

Fluorescence signals that are proportional to the amount of PCR product, can be generated by fluorescent dyes that are specific for double-stranded DNA (dsDNA) e.g. EVA Green, or by sequence-specific fluorescent oligonnucleotide probes. These techniques are described further in Real-Time Polymerase Chain Reaction, ChemBioChem 2003, 4, 1120-1128.

The present invention, described below, utilises the science and chemistry of fluorescence detection as described in the above mentioned documents but utilises a novel light guiding technique, which is particularly applicable to micro sized reaction vessels. The light guide enables greater levels of optical energy to enter and enter such vessels with low cost light sources (LED's) as compared optical planar or fibre waveguides.

According to the invention there is provided a detection system for detecting an agent from within a substance comprising at least one reaction chamber into which the substance is introduced, a radiation source emitting radiation toward the reaction chamber, detection means for detecting radiation emitted by the agent when excited by the incident radiation in which the system further comprises a light guide configured to efficiently direct the incident radiation toward the reaction chamber.

The light guide of the present invention is also amenable to commercial volume manufacture as will become apparent.

The invention will now be described with reference to the accompanying diagrammatic drawings, in which

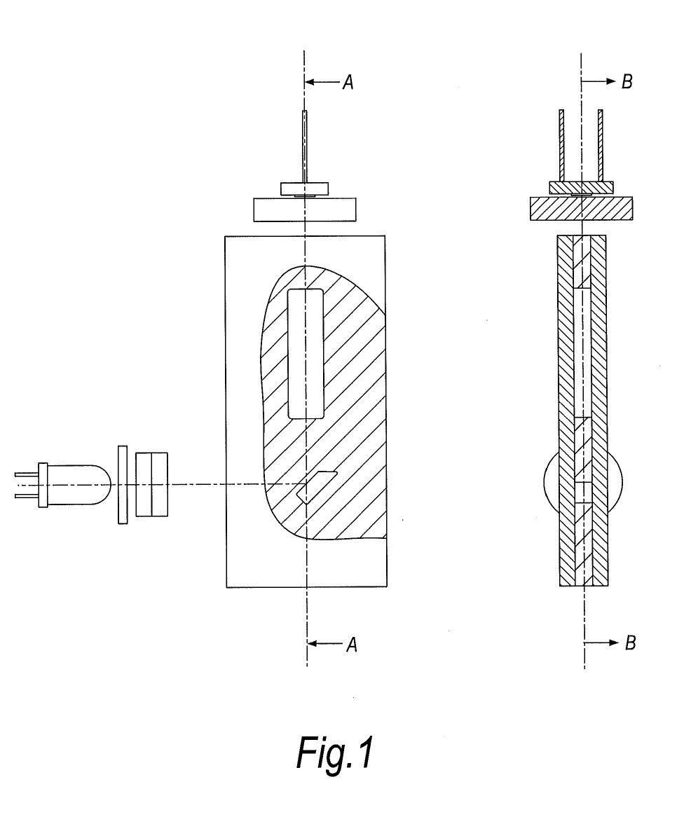

FIG. 1A shows a schematic diagram of a detection system in accordance with one form of the invention including a radiation source, a single reaction chamber embedded in light guide and detection means;

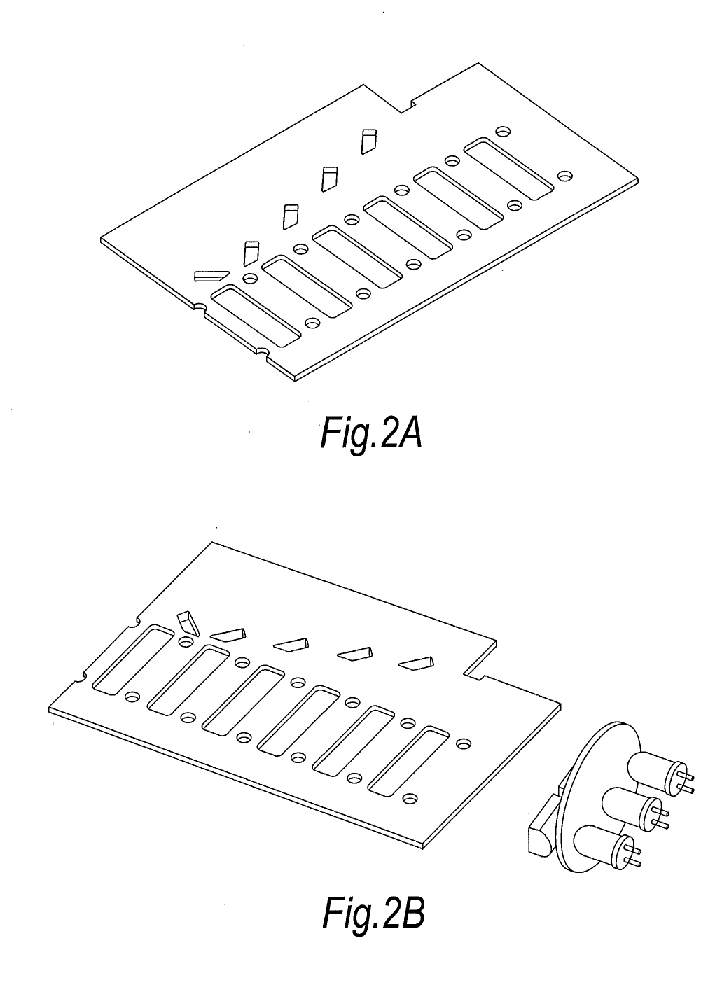

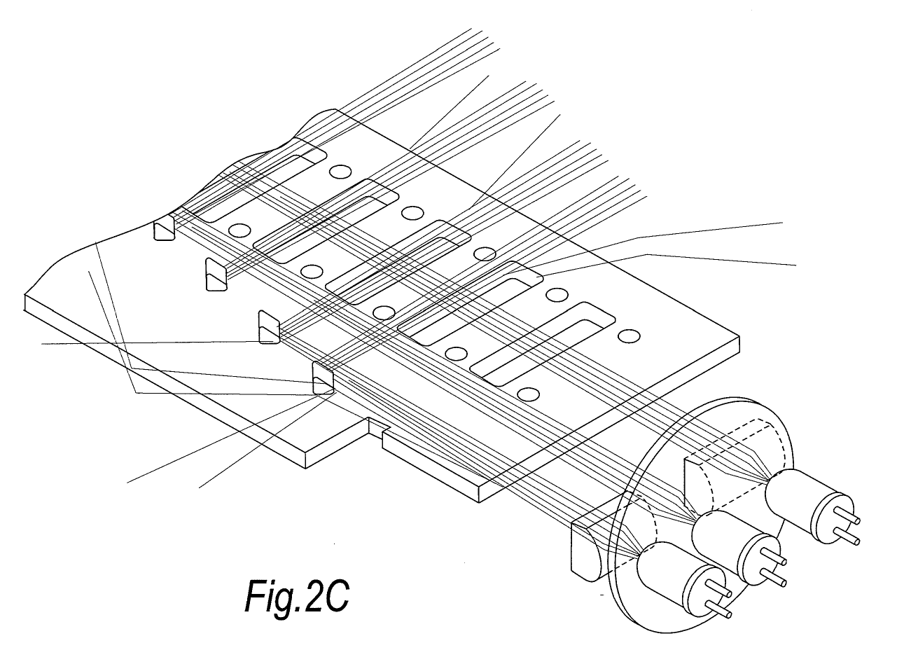

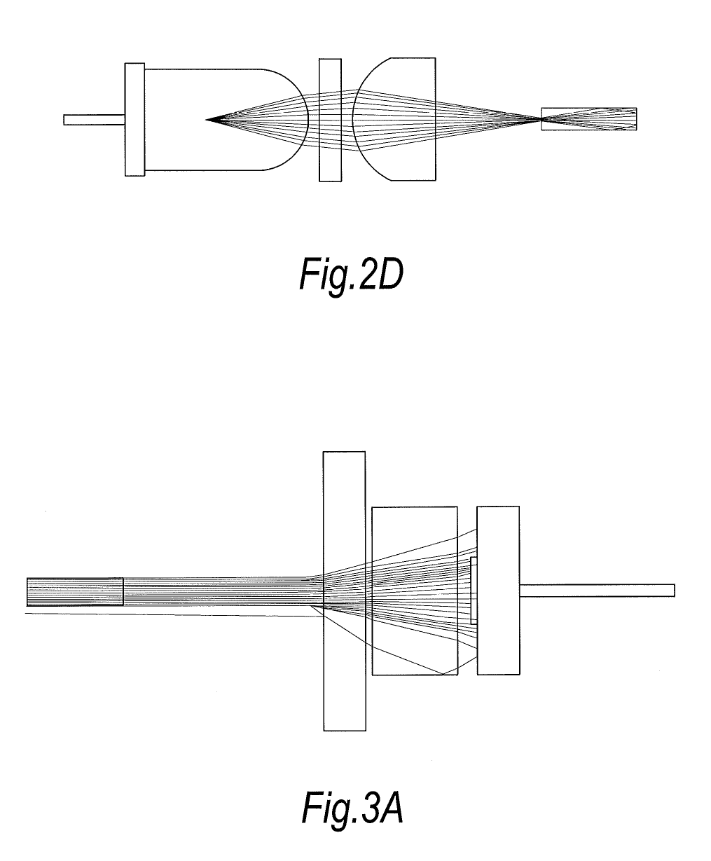

FIG. 2A is a schematic diagram showing part of a light guide in accordance with one form of the invention, using a plurality of reaction vessels and light direction cut outs;

FIG. 2B is schematic view of a radiation source located so as to emit radiation through a filter toward the light guide shown in FIG. 2A;

FIG. 2D shows the radiation paths of the radiation emitted by the source toward the light guide, the radiation being relatively dispersed in one direction whilst being concentrated in a substantially orthogonal direction;

FIG. 2C is a further schematic diagram showing an optical ray path through the light guide;

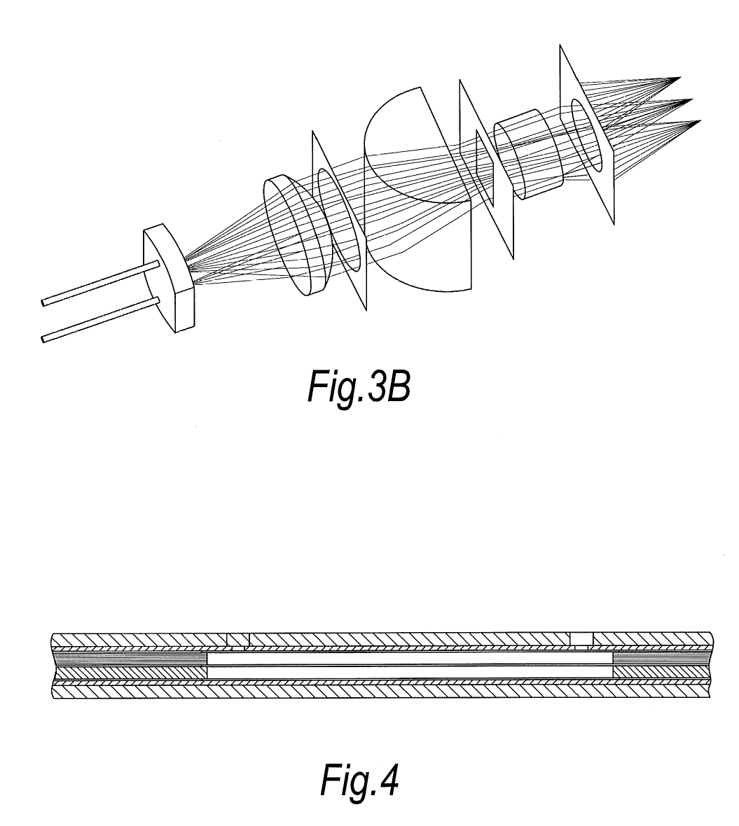

FIG. 3A is a schematic diagram showing collection of the radiation emitted by the fluid within the reaction chamber t through the light guide;

FIG. 3B is a schematic diagram showing one form of and improved optical scheme to collect the radiation onto a detector without improving the surface quality of the light guide; and

FIG. 4 is a schematic diagram showing a sectional view though a reaction chamber constructed from 2 light guides bonded together.

FIG. 1A shows a schematic diagram of a detection system in accordance with one form of the invention utilising a single reaction vessel. The reaction vessel contains the agents of interest mixed with the PCR chemistry and fluorescence tagged as previously described. Optical radiation is directed by a lightguide towards the reaction chamber such as to excite the substance within.

The fluorescently tagged substance within the chamber re-emits optical radiation at a different wavelength than the source radiation. The emitted radiation is now collected by the light guide and directed to a suitable optical radiation detector. The magnitude of the optical radiation emitted by the target substance is indicative of the agents contained within the substance.

The embodiment of the invention described below provides a means of efficiently directing the radiation towards the target substance.

In particular, the invention is used in a system containing a number of micro sized reaction vessels, the vessels containing trace amounts of DNA/RNA targets of interest.

What is described below is the optical component of the detection system. The other subsystems referred to above may be of any form suitable to interact with the optical component such that a suitable PCR system is created.

As shown in FIG. 1A, the lightguide consists of a thin sheet of optically transparent, biocompatible extruded, cast or injection moulded plastic such as PMMA, COP, COC which have two faces substantially parallel and polished to a good optical finish. The thickness of the lightguide would typically be in the range 125 to 1000 microns. The outside surfaces of the sheet are coated (<2 microns thick) with a material such as an optical dielectric thin film coating, protected aluminium or silver such that internal reflection at the coated interfaces is greater than 80% to visible light when the component is in intimate contact with any material.

The biocompatible polymer has one or more reaction vessels (minus top and bottom sides) cut out of the material. FIG. 1A shows a typical arrangement of cut out as used in one embodiment of the invention.

Other useful attributes of the material are that it has a low thermal capacity and relatively low thermal conductivity which minimises power input during the heating stages of the rapid thermal cycling process.

An additional cut out is made into the lightguide for redirecting the light paths towards the reaction chamber. Cut out angles are selected such that light is predominantly reflected because the polymer has a higher refractive index than the surrounding media

This light steering approach, as well as the external coatings, differentiates this polymer lightguide from other designs.

Known manufacturing processes such as precision high speed milling, laser cutting vapour polishing could typically be used to provide the optically clear surface edges from precision extruded or cast PMMA film. Another manufacturing method is to injection mould the components

Top and bottom covers of the chambers are bonded to the light guide and have biocompatible interfaces in the areas that are in contact with the reaction chamber fluids. A sectional view of a typical chamber is shown in section AA of FIG. 1A.

Ports are made in one or more of the covers for the injection of targets of interest and PCR required biochemistry. The top cover and bottom cover contain heating and/or temperature sensing circuitry as well as any other specimen preparation required equipment. The lower cover may include Peltier effect heater/coolers and would be generally cooled by direct impingement air flow.

FIG. 2A shows the arrangement for the provision of excitation light into the light guide. FIGS. 2B and 2C illustrate optical ray traces. The components are:—(a) light guide, (b) flux concentration lens, (c) dichroic blue filter, (d) high optical power blue LED's. The science of excitation of materials by short wavelength light and observation of the Stokes shift by fluorophores is well understood by skilled practitioners and is not entered into in detail here. However, one important difference in the present application is the substitution of plano-cylindrical or aspheric cylindrical optics which are used to concentrate light into a planar material. FIG. 2B show how the rays are spread out in one plane but concentrated in an orthogonal plane.

The concept of the current invention is that the design is robust to cheaper and more in accurate manufacturing processes.

A consequence of these cheaper manufacturing processes is that the edge surface quality is not as good as one would expect to find in high quality glass optics

The rougher surface finish at an air-acrylic boundary in the light path causes additional light energy to be scattered. The cylindrical lens approach mitigates against this energy loss in that for any given sheet thickness a larger cross sectional area for the transmitted light is used as compared with an axisymetric imaging component. More light energy is thus transferred from the LED to light guide because of averaging effects.

This concept could benefit other potential uses for the light guide e.g. illumination systems

FIG. 3A illustrates a simple scheme for collecting the fluorescent light that exits the lightguide. As can be seen, there is a mask a, an emission filter b and a detector c.

In this illustration the roughness of the end face of the light guide has been exaggerated to show that increased scattering occurs and that that a number of light rays miss the central sensitive area of the detector even though it is mounted relatively close to the light guide.

FIG. 3B illustrates an improved optical scheme to collect the light onto a detector without improving the surface quality of the lightguide.

This scheme utilises an anamorphical optical imaging system, consisting of:—a) plano convex lens, b) emission filter, c) negative cylindrical lens d) positive cylindrical lens e) plano convex lens f) detector. The illustration also illustrates masking effects from optical housing elements

A further embodiment of the invention is to bond 2 or more light guides together. FIG. 4 shows a section view though a reaction chamber constructed from 2 light guides bonded together. Such an arrangement could be used to interrogate a duplex PCR chemical mix which contains 2 different fluorophores with differing peak excitation emission responses. Beamsplitters are used in existing schemes but these have optical transmission inefficiencies.

In this way, a low cost light guide is used to direct excitation light to reaction vessels and collect fluorescent light from reaction vessels. A higher quantity of optical flux has been able to be directed to vessels without increasing vessel size or increased power from light source

1. A detection system for detecting an agent from within a substance comprising:
at least one reaction chamber into which the substance is introduced;
a radiation source for emitting radiation toward the reaction chamber;
detection means for detecting radiation emitted by an agent when excited by incident radiation; and
a light guide configured to direct the incident radiation toward the reaction chamber.

2. A detection system according to claim 1 in which the light guide is configured to efficiently direct radiation emitted by the agent towards the detection means such that portions of the agent within a relatively larger amount of substance can be effectively detected.

3. A detection system according to claim 1 in which the light guide forms at least part of the at least one reaction chamber.

4. A detection system according to claim 1 in which the light guide is configured for causing incident radiation to be spread out in a first direction whilst being relatively concentrated in a second direction in which the second direction, is substantially orthogonal to the first direction.

5. A detection system according to claim 1, comprising:
a plurality of light guides arranged such that a first light guide is arranged for guiding radiation emitted by a first agent and subsequent light guides are arranged for guiding radiation emitted by subsequent agents.

6. A detection system according to claim 1 in which each light guide is formed from PMMA, COP, COC or any other suitable plastics material.

7. A detection system according to claim 1 in which an agent to be detected in a substance is DNA or RNA.

8. A detection system according to claim 1 in which the radiation is visible light or any other wavelength of radiation suitable to excite detectable emitted radiation by an agent to be detected.

9. (canceled)

10. A detection system according to claim 2 in which the light guide forms at least part of the at least one reaction chamber.

11. A detection system according to claim 2, in which the light guide is configured for causing incident radiation to be spread out in a first direction whilst being relatively concentrated in a second direction, in which the second direction is substantially orthogonal to the first direction.

12. A detection system according to claim 10, in which the light guide configured for causing incident radiation to be spread out in a first direction whilst being relatively concentrated in a second direction, in which the second direction is substantially orthogonal to the first direction.

13. A detection system according to claim 2, comprising:
a plurality of light guides arranged such that a first light guide is arranged for guiding radiation emitted by a first agent and subsequent light guides are arranged for guiding radiation emitted by subsequent agents.

14. A detection system according to claim 3, comprising:
a plurality of light guides arranged such that a first light guide is arranged for guiding radiation emitted by a first agent and subsequent light guides are arranged for guiding radiation emitted by subsequent agents.

15. A detection system according to claim 4, comprising:
a plurality of light guides arranged such that a first light guide is arranged for guiding radiation emitted by a first agent and subsequent light guides are arranged for guiding radiation emitted by subsequent agents.

16. A detection system according to claim 2 in which each light guide is formed from PMMA, COP, COC or any other suitable plastics material.

17. A detection system according to claim 3 in which each light guide is formed from PMMA, COP, COC or any other suitable plastics material.

18. A detection system according to claim 15 in which each light guide is formed from PMMA, COP, COC or any other suitable plastics material.

19. A detection system according to claim 2 in which an agent to be detected in a substance is DNA or RNA.

20. A detection system according to claim 18 in which an agent to be detected in a substance is DNA or RNA.

21. A detection system according to claim 20 in which the radiation is visible light or any other wavelength of radiation suitable to excite detectable emitted radiation by an agent to be detected.
